(19) United States
(12) Patent Application Publication
(10) Pub. No.: US 2014/0164641 A1
(43) Pub. Date: Jun. 12, 2014

(54) CONGESTION CONTROL FOR DATA CENTER TRAFFIC

(71) Applicant: THE HONG KONG UNIVERSITY OF SCIENCE AND TECHNOLOGY, KOWLOON (HK)

(72) Inventors: Lisha YE, Jiangsu Province (CN); Mounir HAMDI, Kowloon (HK)

(73) Assignee: THE HONG KONG UNIVERSITY OF SCIENCE AND TECHNOLOGY, KOWLOON (HK)

(21) Appl. No.: 13/854,890

(22) Filed: Apr. 1, 2013

Related U.S. Application Data
(60) Provisional application No. 61/735,884, filed on Dec. 11, 2012.

(51) Int. Cl. H04L 12/801

(52) U.S. Cl. CPC H04L 47/10
USPC 709/235

(57) ABSTRACT

Network congestion management techniques are applied in a communication network. Network characteristics and target thresholds can be determined. A transmission mode can be determined. Further, a sending rate can be determined based on the transmission mode and network characteristics. In one aspect, network characteristics at a recent time can be determined to alter sending rates in a network to manage network congestion.

This application claims priority to U.S. Provisional Patent Application No. 61/735,884, filed on Dec. 11, 2012, entitled “DCUDP: AN EFFICIENT UDP WITH CONGESTION CONTROL FOR DATA CENTER TRAFFIC.” The entirety of the aforementioned application is incorporated by reference herein.

### TECHNICAL FIELD

This disclosure relates generally to data centers and data base traffic protocols in connection with a communication network system, e.g., the management of data transmissions in a communication network system.

### BACKGROUND

With rapid growth in information technology, requirements for data storage and transfer are becoming more important. Generally, information technology services use networks that utilize Transmission Control Protocol (TCP) to communicate. TCP is a communications protocol for a transport layer in an Open Systems Interconnection (OSI). An application layer sends service requests to the transport layer and the transportation layer sends service requests with header information to a network layer.

TCP partitions data into packets prior to transmission. Packeting data allows for the transmission of large amounts of data. TCP also transmits sequencing data with packets. This facilitates reassembly upon receipt and retransmission of lost packets, at the cost of increased latency and network load.

User Datagram Protocol (UDP) is an alternative protocol for the transport layer in the OSI model. Generally, UDP is utilized in applications where error checking and correction is either not necessary or not performed in the application (as opposed to at the transportation layer). Applications often utilized UDP when time is more critical than error checking (e.g., real-time online games, streaming media, and Voice over IP). UDP transmits packets or datagrams without sequencing data without handshake dialogue. Thus, a client and server do not need to establish a connection prior to transmission in a UDP system. Since UDP does not utilize error checking for datagrams, datagrams can be lost or delivered out of order. However, UDP transmissions require lower network overhead and have reduced latency in comparison to TCP transmissions.

The above-described conventional techniques are merely intended to provide an overview of some issues associated with current technology, and are not intended to be exhaustive. Other problems with the state of the art may become further apparent upon review of the following detailed description of the various non-limiting embodiments.

### SUMMARY

The following presents a simplified summary to provide a basic understanding of some aspects described herein. This summary is not an extensive overview of the disclosed subject matter. It is not intended to identify key or critical elements of the disclosed subject matter, or delineate the scope of the subject disclosure. Its sole purpose is to present some concepts of the disclosed subject matter in a simplified form as a prelude to the more detailed description presented later.

In various non-limiting embodiments, systems and methods for transmissions of data between network components utilizing traffic and congestion management techniques are described. In one aspect, a device can dynamically manage network congestion based on a determined level of network traffic. For example, a device can determine a level of bandwidth used compared to a total level of bandwidth available, a number of not serviced data packets, and the like. The device can determine a mode of operation based on the level of network congestion. In another aspect, a network can utilize substantially current network characteristics, such as a real queue depth, to determine and select a level of congestion.

A device can manage a rate of transmission based on a transmission mode. For example, a sender can operate in a standard mode to send data packets as frequently as the sender can operate. In another aspect, the sender can operate in a congested mode and constrict sending of data packets to a threshold rate.

A network can apply different transmission management to different senders in the network. In one aspect, various systems and methods disclosed herein can guarantee fairness and convergence during periods of a threshold level of congestion (e.g., bursts of network traffic).

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a high level functional block diagram of a layered network in accordance with various embodiments.

FIG. 2 illustrates a functional illustration of a layered network capable of managing congestion in accordance with various embodiments.

FIG. 3 presents a high level block diagram of a system including a receiver, a sender, and a network component, in accordance with various embodiments.

FIG. 4 illustrates a high level block diagram of packet structures including a data packet and a control packet in accordance with an embodiment.

FIG. 5 illustrates a high level schematic diagram of a network management component in accordance with various embodiments.

FIG. 6 illustrates a high level block diagram of a communication system that can manage network traffic in accordance with various embodiments.

FIG. 7 illustrates a flow diagram of facilitating dynamic congestion control in a network in accordance with various embodiments.

FIG. 8 illustrates a flow diagram of facilitating dynamic network congestion control including managing transmission modes in accordance with various embodiments.

FIG. 9 illustrates a flow diagram of a method for altering transmission parameters in a network in accordance with an embodiment.

FIG. 10 illustrates a flow diagram of facilitating management of congestion including monitoring network traffic trends in accordance with various embodiments.

FIG. 11 illustrates an example block diagram of a computer operable to execute various aspects of this disclosure in accordance with the embodiments disclosed herein.

### DETAILED DESCRIPTION

In the following description, numerous specific details are set forth to provide a thorough understanding of the embodiments. It is noted, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

Moreover, the word “exemplary” where used herein to means serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Embodiments of the invention may be used in a variety of applications. Some embodiments of the invention may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, a wireless communication station, a wireless communication device, a wireless access point (AP), a modem, a network, a wireless network, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or long term evolution (LTE) of the above standards, units and/or devices which are part of the above networks, one way and/or two-way radio communication systems, cellular radio-telephone communication systems, a cellular telephone, a wireless telephone, a personal communication systems (PCS) device, a PDA device which incorporates a wireless communication device, a multiple input multiple output (MIMO) transceiver or device, a single input multiple output (SIMO) transceiver or device, a multiple input single output (MISO) transceiver or device, or the like.

It is noted that various embodiments can be used in conjunction with one or more types of wireless or wired communication signals and/or systems, for example, radio frequency (RF), infra red (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, multi-carrier modulation (MDM), discrete multi-tone (DMT), Bluetooth®, ZigBee™, or the like. Embodiments of the invention may be used in various other devices, systems, and/or networks.

While portions of this disclosure, for demonstrative purposes, refer to wired and/or wired communication systems or methods, embodiments of the invention are not limited in this regard. As an example, one or more wired communication systems, can utilize one or more wireless communication components, one or more wireless communication methods or protocols, or the like.

The term “UDP” as used herein can include, a User Datagram Protocol that may be used in addition to or as an alternative to TCP/IP, for example. Further, UDP systems and methods can include wireless or wired UDP communication, UDP like systems and or methods, UDP communication over a communication network (e.g., the Internet, Ethernet, iWarp, network adaptors with OS bypass capabilities), communications using kernel UDP socket(s) (e.g., in addition to or as an alternative of using kernel TCP/IP sockets), and/or other types of communication. In some embodiments, for example, UDP communication can be used to facilitate, streaming media and applications that are streaming data (e.g., audio, video, text, other streaming media applications, video games, voice over IP (VoIP), video-conferencing, File Transfer Protocol (FTP)), applications in which dropped or erroneous packets are not re-transmitted, applications utilizing transmission of datagrams, packets, and/or time-sensitive datagrams. Further, UDP communications can utilize applications that do not require confirming receipt of packets/datagrams, state-less communication applications, broadcast applications or communications, multicast applications or communications, web-cast applications or communications, non-unicast applications or communications, domain name server (DNS) applications, or the like. In some embodiments, UDP may be used in conjunction with other forms of delivery of information, for example, TCP and TCP like systems and/or methods.

Although some portions of the discussion herein may relate, for demonstrative purposes, to a fast or high-speed interconnect infrastructure, to a fast or high-speed interconnect component or adapter with OS bypass capabilities, to a fast or high-speed interconnect card or Network Interface Card (NIC) with OS bypass capabilities, or to a to a fast or high-speed interconnect infrastructure or fabric, embodiments of the invention are not limited in this regard, and may be used in conjunction with other infrastructures, fabrics, components, adapters, host channel adapters, cards or NICs, which may or may not necessarily be fast or high-speed or with OS bypass capabilities. For example, some embodiments of the invention may be utilized in conjunction with InfiniBand (IB) infrastructures, fabrics, components, adapters, host channel adapters, cards or NICs; with Ethernet infrastructures, fabrics, components, adapters, host channel adapters, cards or NICs; with gigabit Ethernet (GEth) infrastructures, fabrics, components, adapters, host channel adapters, cards or NICs; with infrastructures, fabrics, components, adapters, host channel adapters, cards or NICs that have OS with infrastructures, fabrics, components, adapters, host channel adapters, cards or NICs that allow a user mode application to directly access such hardware and bypassing a call to the operating system (namely, with OS bypass capabilities); with infrastructures, fabrics, components, adapters, host channel adapters, cards or NICs; with infrastructures, fabrics, components, adapters, host channel adapters, cards or NICs that are connectionless and/or stateless; and/or other suitable hardware.

The systems and methods described herein, generally relate to transmissions traffic control in data centers. In one aspect, a data center user datagram protocol (DCUDP) can provide congestion control using an Explicit Congestion Notification (ECN) component. For example, DCUDP can actively monitor congestion based on network characteristics. ECN can be utilized to trigger components to switch transmission modes or maintain a transmission mode when a congestion level is compared to a threshold level.

The various systems, methods, and apparatus described herein employ Explicit Congestion Notification (ECN) in a UDP based protocol for data centers to manage network throughput and congestion. In various examples, DCUDP systems can support a packet loss-retransmission scheme without requiring modification of UDP or UDP-like architecture.

Various other embodiments provide for management of traffic across a network through network congestion control schemes. For example, a device is described having a network monitor component that monitors bandwidth in a network. The device can determine a level of congestion in a network. In another example, a device is described having a congestion control component that can utilize the congestion level to select a mode of operation, such as a standard mode (UDP mode) or a congestion mode. In one aspect, the mode of operation can alter a rate of transmission (e.g., rate packets are sent).

The terms “standard mode,” “UDP mode,” “normal mode,” “non-congested mode,” and the like are used interchangeably, unless contexts suggests otherwise, to refer to a transmission mode for non-congested networks.

In another aspect, the terms “congested,” “congestion,” “network congestion,” and the like are used interchangeably unless context suggests otherwise. The terms can refer to a one or more characteristics, metrics, and/or properties of a network meeting or exceeding a threshold level(s), unless context suggests otherwise. The threshold level(s) being determined as a maximum and/or minimum level(s) of the one or more characteristics, metrics, and/or properties of a network needed to satisfy a condition of a congested network.

In another aspect, a wireless communication method is derived comprising, generating control information, and transmitting the control information through transmissions. Sending rates pertaining to transmissions can be based on Round Trip Delay Time (RTT) parameters. In one aspect, sending rates are determined to achieve fairness during periods above a determined network congestion level.

In yet another aspect, a device can include means for generating control information and means for transmitting the control information. Another device can include means for determining a level of network congestion, means for receiving data, means for sending data, means for altering a rate of transmission, and means managing packet data.

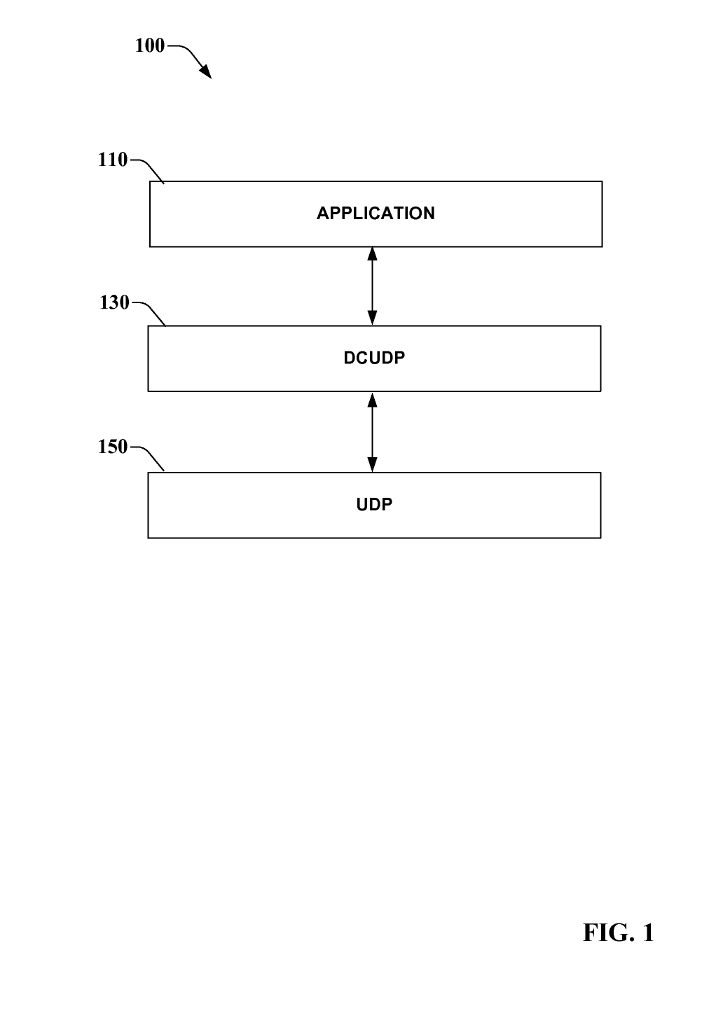

FIG. 1 illustrates a DCUDP system 100 in accordance with various embodiments. Aspects of the systems, apparatuses, or processes explained herein can constitute machine-executable components embodied within machine(s), e.g., embodied in one or more computer readable mediums (or media) associated with one or more machines. Such component, when executed by the one or more machines, e.g., computer(s), computing device(s), virtual machine(s), etc., can cause the machine(s) to perform the operations described.

In an aspect, system 100 can be a multi-layered communication system with a DCUDP lawyer for transferring data over a network (e.g., Internet, intranet, etc.). The system 100 illustrated in FIG. 1 can include an application layer 110, a DCUDP layer 130, and a UDP layer 150. The application layer 110 can pass data through the DCUDP layer 130. The DCUDP layer 130 can use the UDP layer 150 for sending and receiving data. In another aspect, the DCUDP layer 130 and the UDP layer 150 can be part of application layer 110. For example, a seven layer model can comprise the following layers: application, presentation, session, transport, network, data link, and physical. The DCUDP layer 130 and the UDP layer 150 can be comprised in the application layer, in their one distinct layer, or comprised in other layers.

The application layer 110 can provide a user interface to a communication system. In an aspect, a user and the application layer 110 can both communicate with software applications. The application layer 110 can identify communication partners, determine resource availability, and synchronize communication. In an aspect, when identifying communication partners, the application layer 110 determines the identity and availability of communication partners for an application having data to transmit. When determining resource availability, the application layer 110 can decide whether sufficient network recourses or the requested communication exists.

In one implementation, the application layer 110 passes data through the DCUDP layer 130 and the UDP layer 150. The DCUDP layer 130 can include DCUDP applications or components for executing DCUDP functions as described herein. Likewise, the UDP layer 150 can comprise UDP applications, DCUDP applications, or components for executing UDP and/or DCUDP functions as described herein, such as creating UDP sockets (e.g., adding a UDP membership to a socket).

In one aspect, the UDP layer 150 can interact with sockets, protocol handlers, an application programming interface (API), layers of a UDP/IP stack, and/or network communication components.

In embodiments, the UDP layer 150 can utilize multiple network interfaces, for example, the InfiniBand HCA, and the GEth hardware, and/or other ports or cards. For example, the UDP layer 150 can directly handle UDP communications associated with multiple network interfaces, e.g., serially, in parallel, substantially simultaneously, or the like.

The DCUDP layer 130 can comprise a connection-oriented duplex such that each DCUDP entity has at least a pair of senders and receivers. In an embodiment, data flows can be sent from the sender to the receiver, and control flows can be communicated between receivers and/or between senders and receivers. The DCUDP layer can use a handshake packet to set up a connection. In another aspect, the DCUDP layer 130 can send data messages, or data grouped into packets. The packets can be sent from one device in a network to another device in the network. In an aspect, the DCUDP layer 130 can communicate without setting up a special transmission channel or data path.

In one embodiment, the DCUDP layer 130 can group packets into one or more types. The packets can be used to facilitate reliable transmissions and partial reliable messaging. In one example, the packets can be grouped into data packets and control packets. Each packet type can comprise a number of commands or sub-packets. In an aspect, packet types can be predefined by a library. In an example, control packets can include ACK packets, ACK2 packets, NAK packets, Hand-shake packets, keep-alive packets, shutdown packets, and the like.

The DCUDP layer 130 can periodically send ACK packets from a receiver side. A sender side can respond with an ACK2 packet for RTT calculation. In an aspect, the DCUDP layer 130 can use RTT calculations to control congestion across a network. In another aspect, the NAK packet is sent indicating a lost signal. For example, a receiver can monitor a sequence of numbers in received packets. If the receiver determines the sequence is interrupted or incomplete, the receiver can send a NAK packet. The NAK packet can include data indicative of control information to notify the senders of which packets were lost and which packets require re-transmission.

In one example, the system 100 can be implemented on top of and/or in conjunction with UDP (or UDP-like) systems without adding hardware components or structural alterations. In one aspect, DCUDP can add congestion control and reliability control to UDP legacy systems and or methods, while utilizing connection oriented communication.

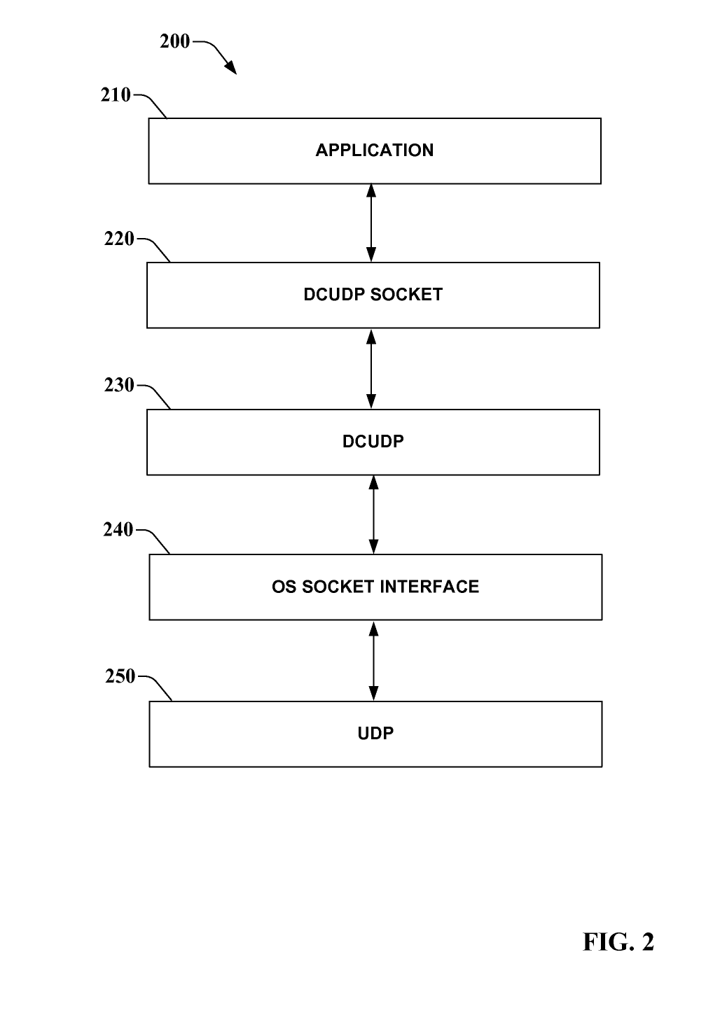

FIG. 2 illustrates a DCUDP system 200 operable in various embodiments of communications systems presented herein. System 200 depicts a layered communication network using socket communication provided by an operating system. As seen in FIG. 2, an application layer 210 interfaces with a DCUDP socket 220. The DCUDP socket 220 establishes a connection with a DCUDP layer (core) 230. Between the DCUDP layer 230 and a UDP layer 250 is an operating system (OS) socket interface 240.

In system 200, the DCUDP socket 220 can establish host-to-host communications. As an example, an application binds a socket to its endpoint of data transmission, which is a combination of an IP address and a service port. A port is a software structure that is identified by the port number, a 16 bit integer value, allowing for port numbers between 0 and 65535. In an embodiment, port 0 is reserved, but is a permissible source port value if the sending process does not expect messages in response.

In another aspect, the DCUDP layer 230, the application layer 210, and the UDP layer 250 can set up socket connections. As an example, a sender device and a receiver device can each implement aspects of system 200, to connect with each other. It is noted that one or more senders can connect with one or more receivers. Packets can be sent from a sender to a receiver (or receiver to sender) through socketed connections utilizing the DCUDP socket 220, for example.

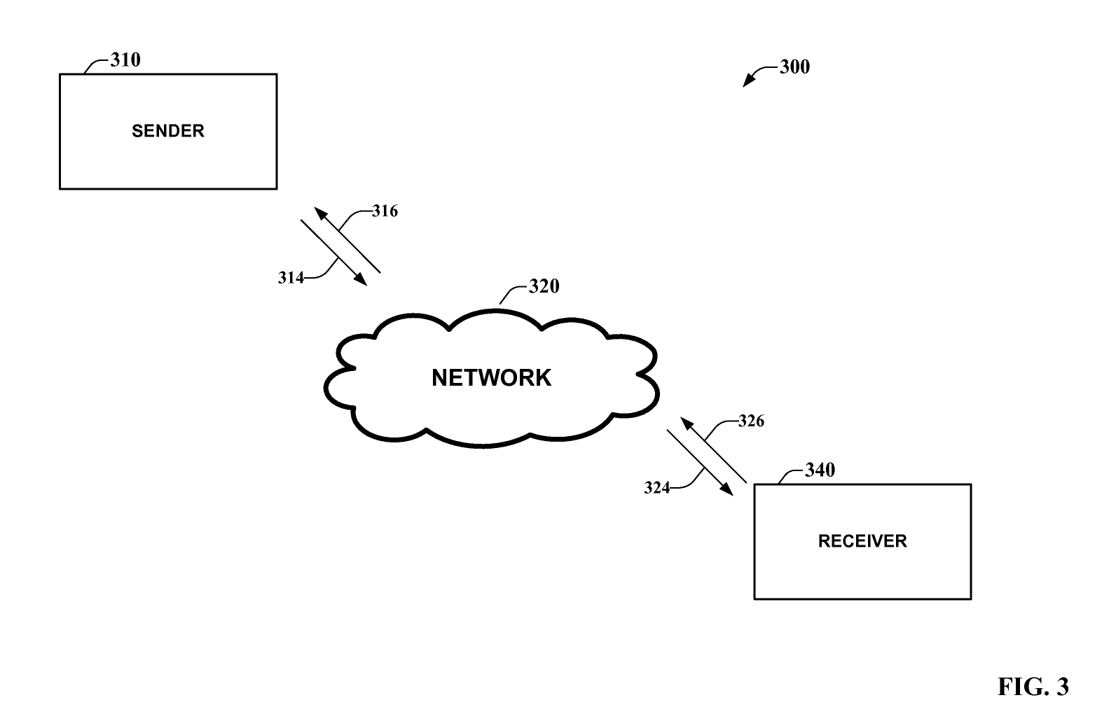

Referring now to FIG. 3, presented is a high level block diagram of a DCUDP system 300 configured to employ a DCUDP functionality. As seen in FIG. 3, system 300 includes a sender 310, a network 320, and a receiver 340. It is noted that the sender 310 and the receiver 340 can be various types of computing devices, such as personal computers, tablet computers, smart phones, set top boxes, desktop computers, laptops, gaming systems, servers, data centers, and the like. The sender 310 and the receiver 340 can connect to the network 320 (e.g., wireless and/or wired connection).

In an embodiment, the network 320 can comprise one or more of the Internet, an intranet, a cellular network, a home network, a person area network, etc., through an ISP, cellular, or broadband cable provider, and the like. The network 320 can comprise an internet protocol interfaces, such as one or more network components, data servers, connection nodes, switches, and the like. In another aspect, the sender 310 and the receiver 340 can be considered as part of the network 320.

In one aspect, the sender 310 and the receiver 340 can establish a connection through the network 320. It is noted that a plurality of other devices can establish a connection through the network 320. However, only the sender 310 and the receiver 340 are shown in FIG. 3 for brevity.

The system 300 can employ congestion control methods to manage network congestion. Congestion control includes a number of different implementations that may differ in which transmission parameters are adjusted and/or in how these parameters are estimated. In contrast, TCP and variations thereof (e.g., UDT), utilize an algorithm called “slow start.” The slow start algorithm, utilizes a buffer size at a sending component set to an initial value. A TCP sending component sends a message and will wait for an acknowledgement by a TCP receiving component. After receiving the acknowledgement, the sending component transmits additional data and receives corresponding acknowledgements. Congestion control methods utilizing the slow start algorithm, or variations thereof, fail to handle burstiness in times when a switch queue depth exceeds a threshold. In an aspect, burstiness can refer to uneven periods of traffic, or spurts of network traffic. As an example, average traffic usage can be measured over a period. During the period there may be spikes in traffic and periods of relative low traffic, as opposed to steady increases/decreases, or constant in network utilization (e.g., traffic). Thus, in a bursty network, an average utilized bandwidth can be manageable but periods of burstiness can cause decreased quality of service or user experience.

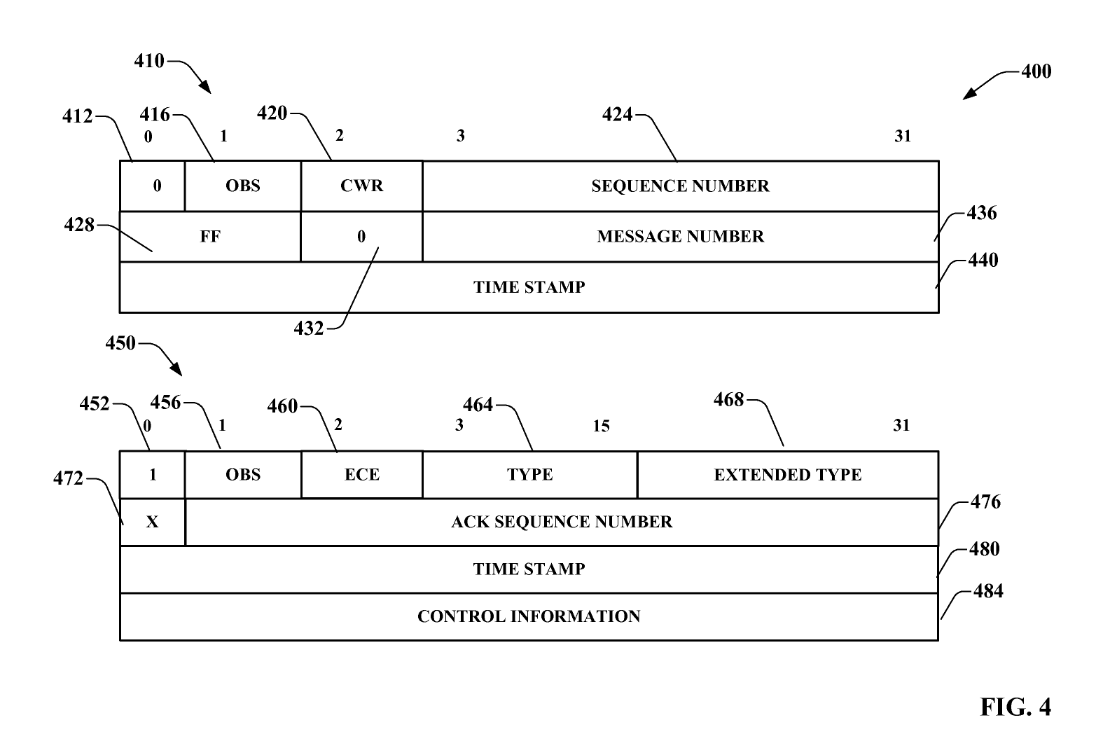

Turning to FIG. 4, with reference to FIG. 3, there illustrated is a high level diagram of a communication packeting system 400 in accordance with various embodiments of DCUDP systems presented herein. A data packet 410 and a control packet 450 are illustrated as exemplary packets. Each packet can comprise any number of bits, 0-31 (total of 32 bits) as illustrated in FIG. 4.

In an aspect, a DCUDP system, such as the system 300, can utilize a sender (e.g., the sender 310) to determine a packet to send. In one embodiment, the sender 310 sets a first bit (or flag bit) 412 of a packet based on a packet type. For example, the first bit 412 of data packet 410 is set to “0” correspond to a data packet type. The first bit 452 of control packet 450 is set to “1” designating the packet as a control packet type. It is noted that various other bits or combinations of bits can specify a packet type. However, for simplicity of explanation, the leading bit (position zero) is utilized herein to distinguish packet types.

The data packet 410 includes an observation bit (OBS bit) 416 to indicate a mode of transmission. In one embodiment, a network component (e.g., the sender 310 or the receiver 340) can set the OBS bit 416. For example, the OBS bit 416 can be set to “1” during a congestion mode and set to “0” during a standard mode. In an aspect, setting the OBS bit 416 to “1” can trigger senders to enter a congestion mode of congestion control, and/or to stay in a congestion mode. Likewise, control packer 450 can include an OBS bit 456 which is similar to OBS bit 416.

In another aspect, the data packet 410 can include a congestion window reduce (CWR) bit 420, that indicates a congestion window is reduced, such as for a packet drop. In one example, if a receiver receives a data packet with a congestion experienced (CE) code point set on, then the receiver sends an ACK with ECE bit set. In an embodiment, the CE code point can be sent at an IP layer, based on a level of congestion. The control packet 450 includes an ECN-echo (ECE) bit 460. The ECE bit 460 can determine whether a sender should slow down transmissions and can notify other components that an ECE bit 460, which is set on, has been received.

The data packet 410 can include a sequence number 424 using the remaining bits after the flag bit 412, the OBS bit 416, and the CWR bit 420. The DCUDP system 300 uses packet based sequencing where the sequence number is increased by one for each sent data packet in the order of packet sending. The sequence number is reset (or wrapped) after it is increased to the maximum number (2²⁹−1).

The next 32-bit field in the data packet 410 is for a message. A first two bits, (“FF” bits) 428, flags the position of the packet is a message. For example, “10” is the first packet, “01” is the last one, “11” is the only packet, and “00” is any packets in the middle. It is noted that other position flagging conventions can be implement. A third bit 432 “0” means if the message should be delivered in order (1) or not (0). A message to be delivered in order requires that all previous messages must be either delivered or dropped. The remaining 29 bits represent a message number 436. The message number 436 is similar to the sequence number 424, but is independent. In one aspect, a DCUDP message may contain multiple UDP packets.

The data packet 410 can also include a 32-bit time stamp 440. The time stamp 440 can indicate when the data packet 410 was sent and a destination socket ID. In one aspect, the time stamp 440 can be a relative value starting from the time when the connection is set up. In another aspect, the time stamp 440 can be based on a time of a central server, a local device, and the like. It is noted that, DCUDP may not require the time stamp 440 for native control algorithms and the time stamp 440 can be included for user defined control algorithms. It is also noted that the data packet 410 can include additional fields, such as destination ID (for UDP multiplexers), UDP socket ID, and the like.

In another aspect, the control packet 450 can include a flag bit 452 similar to the flag bit 412. The control packet 450 can also include type bits 464 the contents of following fields depend on the packet type as determined by the type bits 464. In another aspect, extended type bits 468 can provide more information on the type of control packet. A reserved bit (X) 472 is reserved for use in particular types of the control packet 450. In another aspect, the control packet 450 can use ACK packet sequencing to assignee a unique increasing ACK sequence number 476. The ACK sequence number 476 can be independent of a data packet sequence number (e.g., the sequence number 424).

In another aspect, the control packet 450 can also include a time stamp 480. The time stamp 480 can be a relative value starting from the time when a connection is set up, and/or based on a central clock, a local clock, and the like. Additionally or alternatively, the control packet 450 can include control information 484 (e.g., information indicating which packets are lost, which packets need retransmission, etc.). The control information can facilitate operations of DCUDP communications, such as reliable packet deliver, congestion management, and the like.

Turning back to FIG. 3, the DCUDP system can facilitate one or more different connection setup methods. In one example, DCUDP can support a client/server set up mode and/or a rendezvous set up mode.

In one example, the sender 310 and the receiver 340 can operate in the rendezvous mode. In the rendezvous mode, the sender 310 and the receiver 340 both send a handshake request (e.g., a control packet with a handshake type). The handshake packet can comprise information to setup a connection between the sender 310 and the receiver 340, such as DCUDP version, socket type, initial sequence number, packet size, flow window size, connection type, socket IDs, cookies, IP addresses, and the like. The rendezvous connection setup is typically applied when both peers (e.g., sender and receiver) are behind firewalls, and to provide better security and usability when a listening device is not desirable.

In another example, the sender 310 and the receiver 340 can operate in a client/server mode. In an aspect, the sender 310 and/or the receiver 340 can operate as the server or listener. For clarity, the receiver 340 is assumed to act as the server and the sender 310 is assumed as the client herein. However, it is notes, that the sender 310 can act as the server and the receiver 340 can act as the client.

While in client/server mode, the sender 310 can send a handshake packet, e.g., data 314 sent through network 320, to the receiver 340. The sender 310 can continue sending handshake packets once at an interval until it receives a response handshake, sent from the receiver 340 as a responsive packet 326 through the network 320 and to the sender 310 as data 316, or when a timeout timer expires.

Continuing with the client/server mode setup, when the receiver 340 first receives a connection request from the sender 310, the receiver 340 can create a cookie value based on the sender 310's address and a secret key. The receiver 340 can transmit the cookie value to the sender 310. The sender 310 can send back the same cookie to the receiver 340. In another aspect, the receiver 340 can compare a received handshake packet to determine if a cookie value, packet size, maximum window size, and other data is correct based on its own values. The receiver 340 can send result values and an initial sequence number to the sender 310 as a response handshake packet. The receiver 340 is then ready for sending/receiving data. However, the receiver 340 must send back response packets as long as it receives any further handshakes from the sender 310. In another aspect, the sender 310 can start sending/receiving data once it gets a response handshake packet from the receiver 340.

In another aspect, the DCUDP system 300 can include ECN enabled congestion control management components and/or techniques. As an example, ECN techniques can be applied to increase throughput and manage communication congestion. In one embodiment, the DCUDP system 300 can monitor bandwidth usage across the network 320, at the sender 310, and/or at the receiver 340. The DCUDP system 300 can compare a network congestion level to a threshold. If the network congestion level is not equal to or above a threshold, then the sender 310 and the receiver 340 can transmit data as fast and often as possible, without regard to congestion management (e.g., standard mode). However, when the bandwidth usage is equal to or above the threshold level of usage, the DCUDP system 300 can enter a congestion mode to control the transmissions from the sender 310 and the receiver 340. It is noted that more than two transmission modes can be utilized, as an example, the system 300 can be configured to determine a congestion level and select a transmission mode from a set of transmission modes comprising a UDP mode, a congestion mode, and a heavy congestion mode. In an aspect, the system 300 can alter sending rates for data transmission based on the respective transmission modes.

In various embodiments, the packets 410 and 450 can indicate whether a packet has been lost. For example, sequential number fields in the packets 410 and 450 can be compared to other packets. If sequential numbers are determined to be missing, then a packet can be determined to have been lost. In one example, a NAK packet type can indicate a packet loss signaling. A NAK type packet can be sent if a receiver continues to receive inconsequent sequence numbers in data packets. The NAK type packet can contain control information to notify a sender which packets are lost and which packets need retransmission.

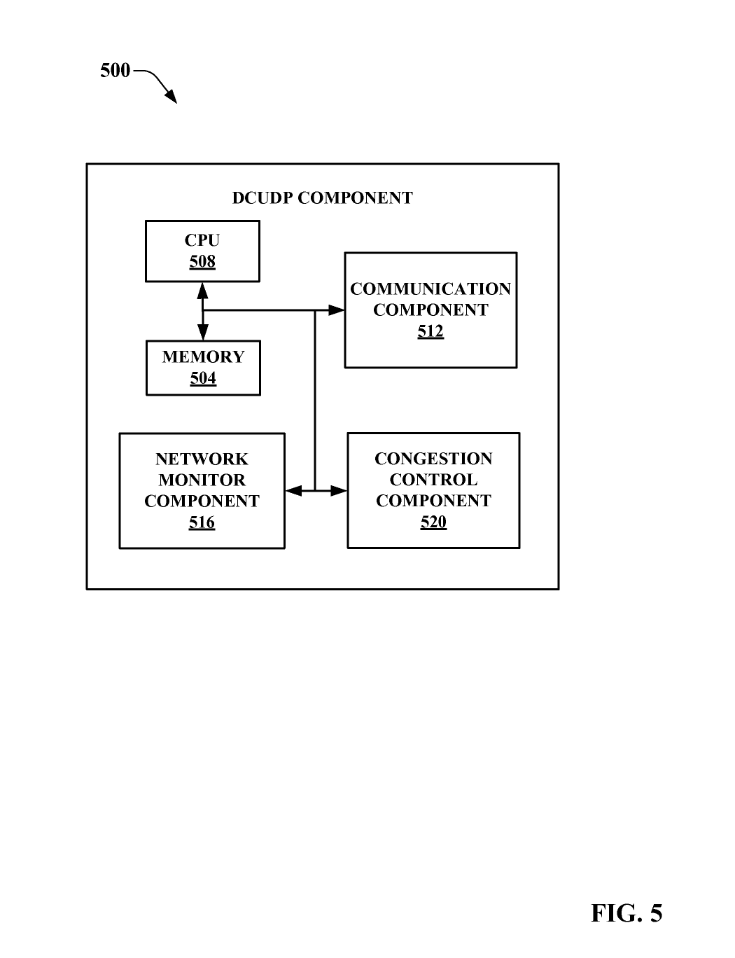

Turning to FIG. 5, presented is a high level schematic diagram of a DCUDP system 500 operable in a DCUDP network system described herein. The DCUDP component can include a memory 504, a processor 508, a communication component 512, a network monitor component 516, and a congestion control component 520. Memory 504 holds instructions for carrying out the operations of components, such as the communication component 512, the network monitor component 516, and the congestion control component 520. The processor 508 facilitates controlling and processing all onboard operations and functions of the components. Memory 504 interfaces to the processor 508 for storage of data and one or more applications of the communication component 512, the network monitor component 516, and the congestion control component 520. The applications can be stored in the memory 504 and/or in a firmware, and executed by the processor 508 from either or both the memory 504 or/and the firmware (not shown). It is noted that DCUDP component 500 is depicted as a single device but can comprise one or more devices coupled together or across a network.

In some embodiments, the DCUDP component 500 can comprise one or more of a server device, a client device, a sender (e.g., the sender 310), a receiver (e.g., the receiver 340), a data center, and/or other computing device. The system 500 can be configured to employ the components in order to manage communication over a network with congestion control management and fairness management. In particular, the system 500 is configured to monitor network traffic and bandwidth utilization of a network. Further, the system 500 can alternate between communication modes based on a triggering event. In one aspect, the system 500 monitors for a triggering event based on network traffic and bandwidth utilization of a network (e.g., resource availability, throughput, etc.).

With reference to FIG. 3, the system 500 can function as the sender 310. In a standard mode (e.g., default UDP mode), the communication component 512 sends packets over a network (e.g., the network 320). In the standard mode, the communication component 512 sends packets across a network as much as possible (e.g., subject to processing speeds, transmission speeds, etc.), similar to UDP-type systems. The communication component can receive keep alive packets from a receiver. In an implementation, the system 500 can utilize a “keep-alive” packet during a UDP mode. In one aspect, the system 500 can use limited types of control packets during the UDP mode. For example, in one implementation, the only type of control packet sent during UDP mode is a keep-alive packet. In various aspects, the keep-alive packet can prevent sudden corruption of a network connection.

In another aspect, the network monitor component 516 can set a CWR bit of a data packet (e.g., the CWR bit 420 of the data packet 410). For example, the network monitor component can determine to set a CE code point on the IP layer based on monitoring of thresholds. The thresholds can include a threshold minimum (e.g., th_min) indicating a minimum level (e.g., a packet in a data packet queue) and a threshold maximum (e.g. th_max) indicating an upper threshold level. In one aspect, the network monitor component 516 can manage one or more queues that store packets to be delivered. In another aspect, th_max and th_min can reflect dimensions of a queue.

In one aspect, the network monitor component 516 can monitor dimensions of one or more queues. Dimensions of queues can include a current depth, an average depth, a rate of depth change, and the like. In an example, the network monitor component 516 determines queue depth based on a current (e.g., real time, near-real time) depth of a queue. A current depth can reflect a depth at a given point in time, whereas an average depth can reflect a queue depth over a period of time with dissimilar start and end times. In one aspect, determining a current depth can allow the network monitor component 516 to determine when DCUDP component 500 is in a congested state. In another aspect, utilizing a current queue depth can facilitate handling of burstiness in a network and can facilitate fairness.

In one embodiment, the network monitor component 516 can set a value for th_max. The th_max can be determined to control a greedy transmission, such as a transmission using respectively more bandwidth than other transmissions. As an example, th_max can be determined as long as the following equation stands, assuming th_max is a maximum threshold for a queue size, Max_{qsize} represents a maximum switch buffer size, RTT_{idle} represents a RTT during a idle times, Interval represents an average sending interval, Delay represents an average link delay, N represents an expected maximum number of senders:

$$th\_max + N \frac{{RTT}_{idle} + th\_max * Delay}{Interval} - \frac{{RTT}_{idle} + th\_max * Delay}{Delay} \leq {Max}_{qsize}$$

The threshold th_max can be used to trigger a switch from a standard mode to a congestion mode. In another aspect, the system 500 can be configured to retain packets after a queue grows larger than th_max. It is noted that packets may be dropped on a selective basis (e.g., importance, fairness, etc.), according to a threshold, and the like.

It is noted that the CWR bit can be set at an IP layer by an intermediate node in a network. Likewise, it is noted that the one or more queues can be monitored at an IP interface by intermediate nodes. It is noted that an IP interface can comprise edge switches, one or more queues, servers, and the like.

In one aspect, the system 500 can send data indicating a packet is a DCUDP (e.g., ECN Capable Transport) by marking them with a CE code point. In various embodiments, the network monitor component 516 can set the CE code point instead of dropping pockets in order to signal impending congestion.

In another aspect, the network monitor component 516 can receive data triggering a switch from a standard mode to a congestions mode. As an example, the communication component 512 can receive packeted data indicating that the DCUDP device 500 should enter a congestion mode. With reference to FIG. 4, the control packet 450 can comprise data indicating a packet type of ACK as determined by the type 464 and/or extended type 468. The control packet 450 can also comprise the OBS bit 456 set to “1” to indicate entering congestions mode.

In congestion mode, the congestion control component 520 can generate control packets for the communication component 512 to send. For example, the congestion control component 520 can generate an ACK2 type packet, with an OBS bit set to “1” (e.g., on).

In another aspect, the congestion control component 520 can alter a packet sending rate (e.g., interval). The congestions control component can determine a range of rates for which packets can be sent. In one embodiment, a number of rates are determined, such as a rate at which packets are sent (Rate_{data}) and maxim rate a sender can send data (Rateₘₐₓ). It is noted that the congestion control component 520 can determine to send at least one packet per RTT, however the congestion control component 520 can be configured such that m packets are sent per y RTTs, where m and y are numbers. In one aspect, values for m and y can be selected to achieve a level of fairness. In one aspect, Rate_{data}, Rateₘₐₓ, and Interval_{data}, can be expressed as:

$${Rate}_{data} = \frac{C * {10}^{6}}{8 * PktSize} ( packets \text{/} sec )$$

$${Interval}_{data} = \frac{1}{{Rate}_{data}} ( sec )$$

$${Rate}_{max} = {Rate}_{data}$$

In congestion mode, the congestion control component 520 can manage transmission to control congestion among a network or components thereof. In one aspect, the control component 520 can react to various types of control packets while in congestion mode. In an aspect, the congestion control component 520 no longer determines Rate_{data} or Rateₘₐₓ when an ECE is received. Rather the congestion control component 520 receives ACK packets at an interval of RTT and responds accordingly. As an example, one or more data packets are received every RTT. In another aspect, responding to ACK packets can control a growth rate.

In an embodiment, the congestion control component 520 applies a rate adjustment lock. A rate adjustment lock can be reset as false each time a data packet is sent at each interval (e.g., Interval_{data}). As an example, the congestion control component 520 can apply a rate adjustment lock, (e.g., freeze command) such that transmissions are not slowed down greater than needed. In an aspect, the rate adjustment lock can gradually slow down the sending rate. It is noted that the rate adjustment lock can be applied at different intervals than Interval_{data}, such that the congestion control component 520 can manage rate adjustments according to desired intervals, based on a target adjustment rate, and the like.

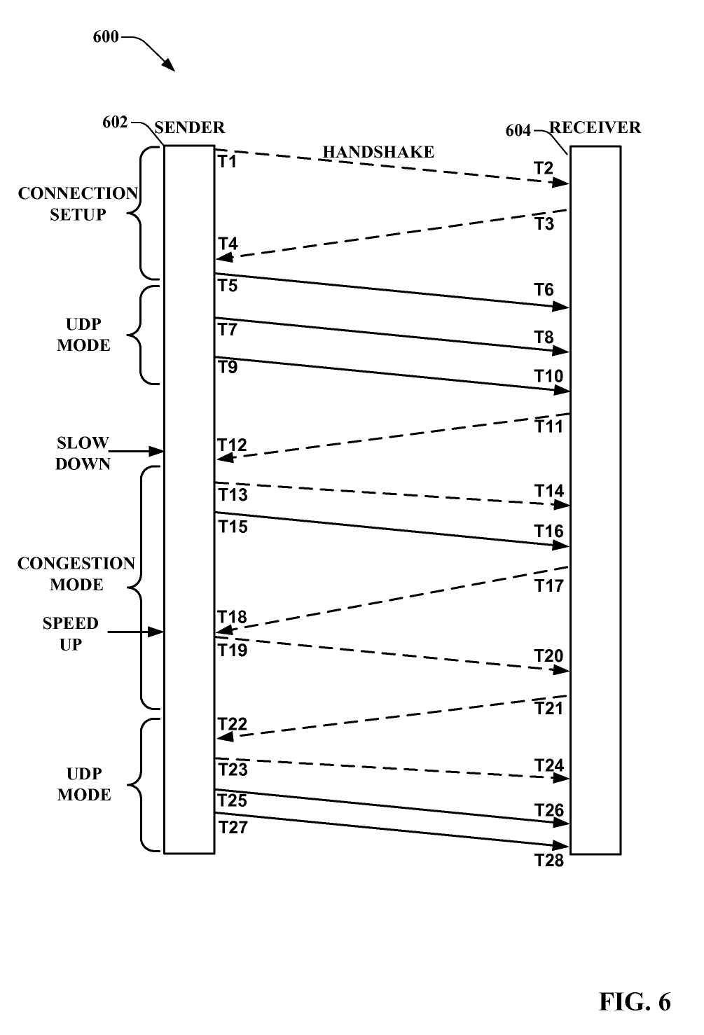

Turning now to FIG. 6, there illustrated is high level block diagram of a DCUDP system 600 in operation. The DCUDP system 600 is depicted with two DCUDP components, a sender component 602 and a receiver component 604. In various implementations, additional components are utilized. However, for brevity, the DCUDP system 600 is described herein without additional components for readability. In one aspect, the sender component 602 and the receiver component 604 can comprise the DCUDP component 500 (FIG. 5), the sender 310 and the receiver 340 respectively (FIG. 3), and/or one or more layers of DCUDP stack (FIGS. 1 and 2).

As depicted, the sender 602 and the receiver 604 can be configured to send and receive messages, e.g. packeted data, data packets, control packets. Each packet may contain information as depicted in FIG. 4. In an embodiment, packets can be sequentially ordered to facility packet loss management. However, it is noted that packets may not be ordered, may be ordered in accordance with other conventions, and the like.

In an aspect, packets are sent from the sender 602 or the receiver 604 at a first time and received by the other at a second time. For illustrative purposes, a series of communications are depicted as sent at time Tz and received at Tz+1, where z is a number. It is noted that each time, T1-T28, can be separated by a length of time, (microseconds, milliseconds, seconds, etc.), occur simultaneous, and/or in various orders. It is noted that, each communication can comprise one or more packets, however a communication is described as a single packet sent from one component to the other, for readability. It is further noted that communications are depicted as non-overlapping and at various times for readability. Further, unless context suggests otherwise, any communication can overlap, can be in a different order, can be substituted by other communications, and/or can pass through various network components, etc. For example, a message starting at T3 can be sent from the receiver 604 through various components and be received by the sender 602 at T4. Although depicted with 18 messages sent from either the sender 602 or the receiver 604 to the other, it is noted that a different amount of messages can be sent and received in the system 600, likewise the sender 602 and the receiver 604 can send messages to and/or receive messages from various other components not shown for readability.

FIG. 6 also depicts a number of stages of the system 600. While described in the order connection setup, UDP mode, congestion mode, and UDP mode, it is noted that the stages can be in various orders. In another aspect, unless context suggests otherwise, a different amount of stages can be present, the stages can last for an indeterminate period, and the stages can comprise an indeterminate amount of messages.

In an embodiment, the system 600 can be in a connection setup stage, where the sender 602 and the receiver 604 are not connected at T1. Depending on a desired mode, the system 600 can communicate various packets between the sender 602 and the receiver 604. For example, if in a rendezvous mode, the sender 602 sends a handshake request at T1 to the receiver 604 who receives the handshake request at T2. The receiver 604 can also send a handshake request at T3 to the sender 602 that can receive at T4. In an aspect, a handshake request can comprise a control packet with a handshake type. The handshake request can comprise information to setup a connection between the sender 602 and the receiver 604, such as DCUDP version, socket type, initial sequence number, packet size, flow window size, connection type, socket IDs, cookies, IP addresses, and the like.

In another example, the system 600 can operate in a client/server mode. In client/server mode, the sender 602 can send a handshake packet at T1, e.g., data 314 sent through network 320, to the receiver 340. The sender 602 can continue sending a handshake packet (additional handshake packets not shown) until it receives a response handshake, sent from the receiver 604 as a responsive packet at T3, or when a timeout timer expires. In another aspect, the receiver 604 can create a cookie value, after receiving a handshake request at T2, based on the sender 602's address and/or a secret key, for example. The receiver 604 can sent the cookie value at T3 and the sender 602 can receive at T4. The sender 602 can send back the same cookie to the receiver 604. In another aspect, the receiver 604 can compare a received handshake packet to determine if a cookie value, packet size, maximum window size, and other data is correct based on its own values. The receiver 604 can send result values and an initial sequence number to the sender 602 by a response handshake packet. The receiver 340 is then ready for sending/receiving data. However, the receiver 604 can send back response packets as long as it receives any further handshakes from the sender 602.

In another aspect, the sender 602 can send communications (e.g., data packets), in a UDP mode, once it gets a response handshake packet from the receiver 604. As an example, the sender 602 can send data packets at T5, T7, and T9. In the UDP mode, the sender 602 can send data packets as frequently as network components can process them (e.g., sends data packets as fast as the system 600 can process), without regard for network resources or congestion control. In another aspect, the sender 604 can intermittently respond to the receiver 602's messages with keep alive packets. However, it is noted that the sender 604 can respond with ACK packets in some embodiments. In one embodiment, a responsive message can comprise quantified data indicating if received data packets were received sequentially or if a packet was lost. The responsive messages can be sent periodically, such as every 10 ms in a 10 GBit Ethernet network, for example.

In an example, a message sent from the sender 602 at T9 can comprise a data packet with an OBS bit set to “0,” indicating the sender 602 is in a UDP mode. At an IP layer, a CE code marking (ECN marking) can be set on. The CE code marking can be set depending on traffic across a network (e.g., resource usage, queue size, time delays, or other metric). In one example, the ECN marking is set based on thresholds th_max and th_min, as described herein.

In another aspect, the receiver 604 can receive a message at T10 with a CE code marking set on (e.g., set to 1). The receiver 604 can prepare a responsive message triggered by receiving a message with a CE bit set on. In one example, the responsive message sent at T11 is an ACK control packet with the OBS bit set to “1” and the ECE bit set to “1.” In one aspect, the sender 602 can receive the ACK control packet at T12. The ACK control packet can trigger one or more responsive actions from the sender 602. For example, in response to the ACK control packet received at T12, the sender 602 can enter a congestion mode. In a congestion mode, the sender 602 can control data packet communications for congestion management. In one example, the sender 602 can slow down sending of data packets, as described herein, send a control packet with an identical sequence number or next number in a sequence (e.g., ACK2 control packet) at T13, set an OBS bit for data packets to 1, determine intervals for sending data, determine thresholds, and the like.

In another aspect, the receiver 602 can receive a control packet (e.g., ACK2) from the sender 602 at T14. In an aspect, receiving an ACK2 control packet can trigger the receiver 604 to calculate recent RTT based on peers. A peer can be a set of control packets (e.g., ACK, ACK2, etc.) that represent related communications, such as communications that require a response. It is noted that peers can be sent from a single component or from multiple components (e.g., multiple senders). In an example, the receiver 604 can calculate a RTT and send ACK packets at an interval, Interval_{ACK}, based on a RTT. In an embodiment, a RTT for a most recently received packet can be denoted as rtt_{current}. The rtt_{current} can be a function of a difference between timestamps of an ACK packet and an ACK2 packet. In one example, the rtt_{current} can be represented as the equation: rtt_{current}=Timestamp_{ACK2}−Timestamp_{ACK}, where Timestamp_{ACK} is a timestamp of the most recently created ACK packet, and Timestamp_{ACK2} is a timestamp for the peer ACK2 packet of the most recently created ACK packet. It is noted that the timestamps can be stored by the receiver 604, the sender 602, other network components, or be comprised in packets (e.g., ACK packets, ACK2 packets, etc.). In one aspect, the RTT can be determined based on a current RTT, (rtt_{current}), and a number α, where α can be a predetermined value or calculated based on network characteristics. In an example, the RTT and the interval_{ACK} can be represented as the following equation, where α is set at 0.125:

RTT=(1−α)*RTT+α*rtt_{current}

Interval_{ACK}=RTT

In an embodiment, the receiver 604 can set an initial interval for sending packets to an idle value, such as RTT_{idle}. The receiver 604 can calculate the RTT, rtt_{current}, and Interval_{ACK} upon occurrence of a triggering event (e.g., receiving an ACK2 packet). For example, the receiver 604 can send an ACK packet at T17, the sender 602 can receive the ACK packet at T18, and the sender 602 can respond with an ACK2 packet at T19.

In a congestion mode, the sender 602 can send data packets, e.g., at T15, according to congestion control management techniques. For example, the sender 602 can restrict sending of data packets based on a time threshold (e.g., one packet every RTT), based on a queue size, based on control data received in control packets (e.g., congestion levels indicated by data in ACK control packets), and/or other desired metric. A congestion level can be monitored based on a number of ACK packets sent/received over a period of time, a number of ACK packets with ECN echo bits sent over a period of time, and the like. In another aspect, the sender 602 can gradually slow down transmissions according to a rate adjustment lock, as described herein. In one aspect, the sender 602 can continue to send data packets at one interval and the receiver 604 can continue to send ACK packets at a second interval as long as the congestion mode continues. Additional communications are not shown for brevity, however, it is noted that congestion mode can continue for an indeterminate period and an indeterminate number of communications (packets) can be sent.

In an embodiment, the sender 602 can speed up sending of data packets during congestion mode based on control data received from the receiver 604, e.g., control data received at T18. For example, a data packet send from the sender 602 at T15 can have a CE bit set to “0” (e.g., off). The receiver 604 can transmit control data reflecting the CE bit set off to the sender 602 through a control packet sent at T17 to the sender 602 at T18. In another aspect, the sender 602 can transmit an ACK2 packet at T19 to the receiver 604 at T20.

The sender 604 can observe a congestion level on a network during the transmissions and determine if a congestion mode should end. In one example, the CE bit can be set to “0” (e.g., off) in the packets sent at T15 and T19. The receiver 604 can determine that the congestion mode should end based on the CE bit being off for a threshold period or threshold number of packets, RTT alterations, ECE alterations, and the like, as described herein. Determining the threshold has been reached can trigger the receiver 604 to send a control packet indicating a threshold has been reach (e.g., ACK packet with an OBS bit set off) at T21 to the sender 602. The sender 602 can respond with a control packet (e.g., ACK2 packet) at T23 comprising data indicating a mode is changed (e.g., OBS bit changed). The receiver 604 can receive a control packet indicating a mode is changed at T24. In an aspect, the control packet received at T24 can trigger the receiver 604 to stop sending ACK packets. In another aspect, the sender 602 can resume data transmissions in a UDP mode at an increased sending rate (e.g., sending packets at T25 and T27 to the receiver 604 that respectively receives the packets at T26 and T28).

In an embodiment, the receiver 604 can store data, related to communication, to facilitate congestion control management. In one aspect, the stored data can comprise information related to received/sent packets. For example, the information related to the packets can comprise a count of received ACK2 packets received, a count of packets received with CE bits set on and/or of, a value representing time delay between packet transmission, and the like. It is noted that data can be stored in various network components, such in network components comprised in an IP interface. In an aspect, the stored data can be utilized to determine if a mode should switch (e.g., switch from congestion mode to UDP mode. In embodiments, the stored data can comprise information received over a period. As an example, the receiver 604 can utilize information determined to meet a definition of recent information. In an aspect, recent information can be defined as information stored for no longer than threshold period, information stored relatively more recently than other information, and the like. It is noted that recent information can be defined respective of a period of time, number of events, and/or any other relative means of measurement that can be utilize to track changes in data.

In one embodiment, the receiver 604 sets a value K for a window size, where K is a number. A window size can be a threshold value utilized to control a length of a set, table, queue, and the like. As an example, the receiver 604 can store a set of recent RTT values (e.g., in a table, first-in-first-out (FIFO) stack, etc). The receiver 604 can store up to K RTT values. If a RTT value is received, the receiver 604 can delete the oldest RTT value, oldest respective of other RTT values, in the table and replace it with the received RTT value. In another example, the receiver 604 can store entries for a percentage of data packets received with a CE bit set on. The receiver 604 can store K entries and as a new entry is received, the oldest entry can be removed and replaced with a new entry.

In an aspect, the receiver 604 can utilized the stored data to determine congestion trends. Congestion trends can comprise determining timing trends (e.g., if delay is being altered), queue trends (e.g., as indicated by CE bits), packet sending trends, and the like. In an example, the receiver 604 stores K recent RTT values and can determine a number of RTT values that are smaller than a previously received RTT value. In an aspect, the receiver 604 can determine to trigger a switch in congestion modes based on the congestion trends. The receiver 604 can notify the sender 602 of the switch by sending an ACK control packet at T21 with an OBS bit set to “0.” In an aspect, determining congestion trends can keep the system 600 from switching transmission modes too often. As an example, the system 600 can be in a congestion mode when a queue depth falls below a threshold. However, the queue depth can rise above the threshold by the time the next data packet is sent. Accordingly, basing a switch of transmission modes on network trends and a threshold can keep a system from switch modes when a condition is near a threshold.

An exemplary algorithm is given below where the receiver 604 can monitor the congestion trends and determine to trigger a switch based on one or more conditions. It is noted that the below description is given for clarity and is only one of various embodiments. Accordingly, this disclosure is not limited to the below algorithm. The receiver 604 can checks the CE bit for every received data packet and determine whether to return ECN-echo. Therefore, for every K recent data packets received, the receiver records the portion (p_{ecn}) of the packets, with the CE bit set, as an entry in a p_{ecn} Window table of size K. When K entries are stored, the receiver 604 calculates the percentage of the p_{ecn} entries that are smaller than the previous one. The window stores the ECN trends of at most K² recent packets received. The receiver 604 can alter a sending interval (Interval_{ack}) to a fixed interval of β*RTT_{idle} if the following conditions are met, (note that θ_{ecn} is 0.5, β is 2, and θ_{RTT} is 0.2, but can be altered if desired):

$$where$$

$${P}_{pcen \leq {p}^{′} ecn} = \frac{{NumberOfP}_{ecn} \leq {P}_{ecn}^{′}}{{NumberofP}_{ecn}}$$

$$if ( {P}_{pcen \leq {p}^{′} ecn} < {θ}_{ecn} , \\ AND , {P}_{RTT < {RTT}^{′}} < {θ}_{RTT} , \\ AND , {P}_{pcenNewest} = 0 )$$

$$then$$

$${Interval}_{ACK} = β * {RTT}_{idle} ( β \geq 1 )$$

If the above conditions (condition set 1) are met, then the receiver 604 can check condition set 2 to determine if congestion mode should be exited. If condition set two is met, then the receiver 604 can set the OBS bit to “0” for an ACK packet. Given that P_{rtt≦rtt′}=(Number of RTT<RTT′)/(Number of RTT), condition set 2 is given as:

P_{pcen≦p′ecn}=1,AND

P_{RTT<RTT′}=1,AND,

P_{pcenNewest}=0

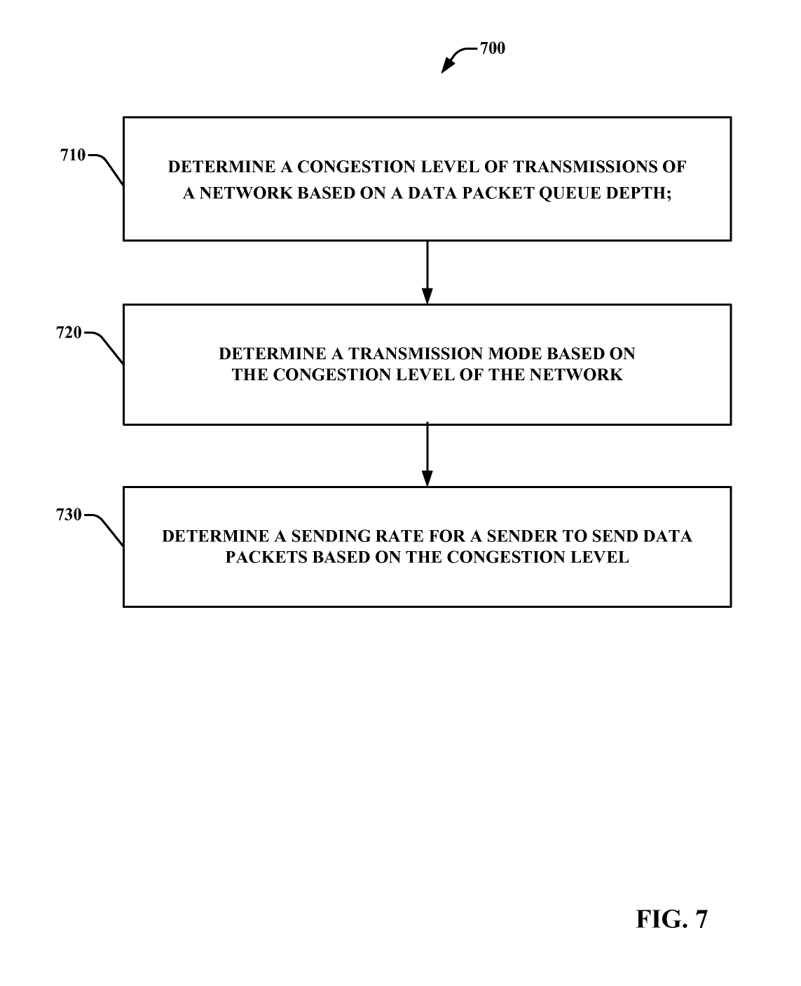

In view of the example system(s) and apparatuses described above, example method(s) that can be implemented in accordance with the disclosed subject matter are further illustrated with reference to flowcharts of FIGS. 7-10. For purposes of simplicity of explanation, example methods disclosed herein are presented and described as a series of acts; however, it is noted that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methodologies. Furthermore, not all illustrated acts may be required to implement a described example method in accordance with the subject specification. Further yet, two or more of the disclosed example methods can be implemented in combination with each other, to accomplish one or more features or advantages herein described.

Turning to FIG. 7, with reference to FIGS. 1-6, there illustrated is an exemplary method 700 to monitor congestion in a network and manage congestions through switching modes of transmission. In an aspect, method 700 can efficiently manage communications between components in a network (e.g., senders, receivers, etc.) and support reliable transmissions and fairness. It is noted that the efficiency and reliability of method 700 results from using various aspects of this disclosure.

At 710, it is assumed that variables are set in accordance with various aspects of this disclosure, and that a sender and a receiver are connected for transmission. For example, the sender 602 and the receiver 604 can have a connection setup (e.g., handshake). At 710, a congestion level of a network can be determined by network conditions, such as a data packet queue depth, a number of transmissions awaiting processing, and the like. In an aspect, the network conditions can be instantaneous conditions. In an aspect, instantaneous conditions can comprise conditions measured at a particular time rather than averages (e.g., conditions determined over a period of time). In one aspect, an instantaneous condition can be sensitive to congestion relative to averages.

For example, a queue parameter (e.g., length) can be determined. A congestion level can be determined by a triggering event. A triggering event can be a metric (e.g., queue parameter, time period, etc.) meeting a threshold. In an aspect, a metric can also comprise a notification (e.g., a CE code point bit set). It is noted that various implementations can provide means for determining the congestion level of a network, network conditions, and the like.

At 720, a transmission mode based on the congestion level of the network is determined. In an aspect, a system (e.g., system 600, system 500, system 400, etc.) can provide means for determining a transmission mode and/or switch from one transmission mode to another. For example, a receiver can send an ACK control packet with data indicating that a sender should switch transmission modes. In one example, a transmission mode can switch from a UDP mode to a congestion mode and vice versa.

At 730, a sending rate for a sender to send data packets based on the congestion level and/or the transmission mode can be determined. In one aspect, determining the sending rate can comprise adjusting a previous sending rate according to the determined sending rate. In an aspect, a system (e.g., system 600, system 500, system 400, etc.) can provide means for adjusting the sending rate, means for determining an updated sending rate based on a round trip delay time, and the like.

In various implementations, the method 700 does not drop packet. In an aspect, as a queue size grows past a threshold (e.g., th_max), the method 700 retains packets. Retaining packets can prevent and/or reduce packet loss in a network.

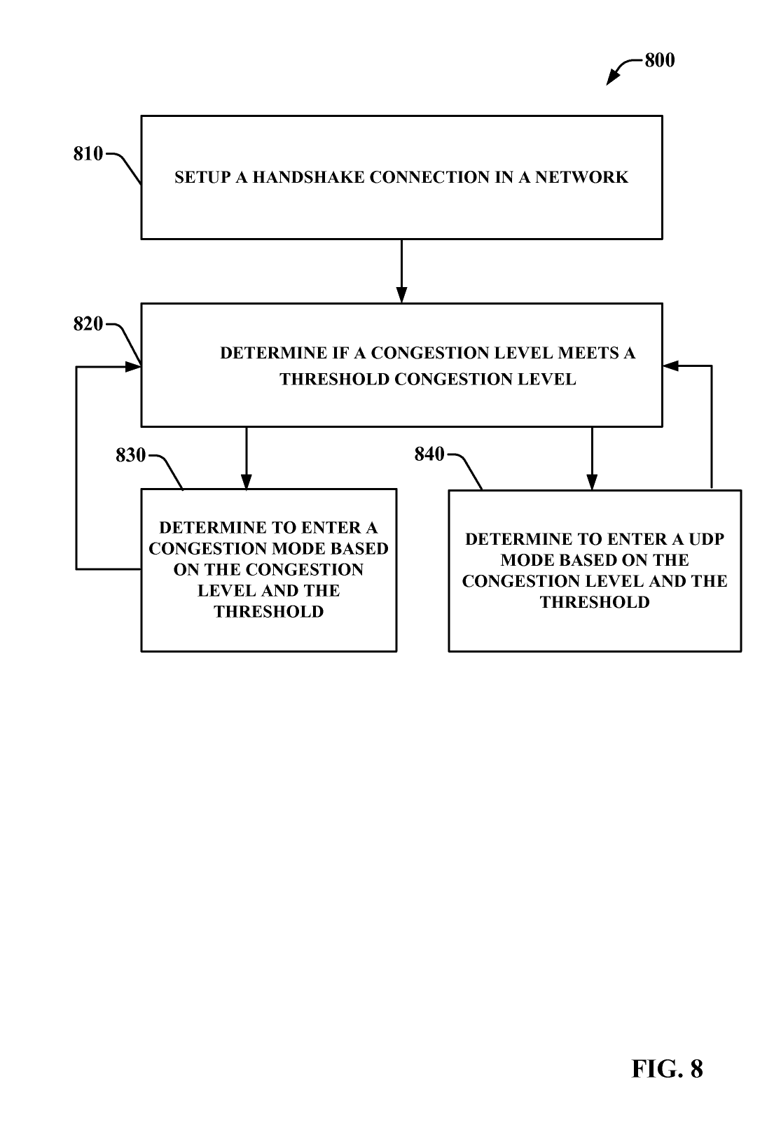

FIG. 8 presents a high level flow diagram of a method 800 for efficient network congestion management in accordance with the congestion schemes of this disclosure. At 810, a handshake connection in a network can be set up. In an aspect, 810 can include client/server and/or rendezvous connection transmissions (e.g., FIG. 6) between components (e.g., senders and receivers), setting of sockets, and the like.

At 820, it can be determined if a congestion level meets a threshold congestion level. For example, a system can determine if a queue depth, storing packets to be processed, meets a threshold queue depth. If the congestion level does not meets a threshold congestion level, then the method 800 can proceed at 830. If the congestion level does meets a threshold congestion level, then the method 800 can proceed at 840.

At 830, a system can enter a UDP mode. A UDP mode can be a standard transmission mode corresponding to congestion of a network being below a threshold characterizing a congested network. It is noted that a system can enter a congestion mode as a network connection is set up. The method 800 can continue at 820.

At 840, a system in a UDP mode can switch to a congestion mode based on network characteristics, in accordance with various aspects of this disclosure. As an example, a system can switch based on availability of network resources, based on a time period, etc. In an aspect, switching to a congestion mode can comprise determining an interval to send communications, sending transmissions according to an interval, altering an RTT, and the like. The method 800 can continue at 820.

In an aspect, at 820, if the previous mode was a congestion mode and it is determined to enter a UDP mode, then 820 can include determining a condition defining congestion of a network is no longer present, and/or determining as a function of network characteristics and target parameters (e.g., energy consumption, network exploration, through put, and accuracy) that a congestion level has decreased. In an example, a system can monitor communications from a receiver and determine differences between time periods of respective communications are below a threshold.

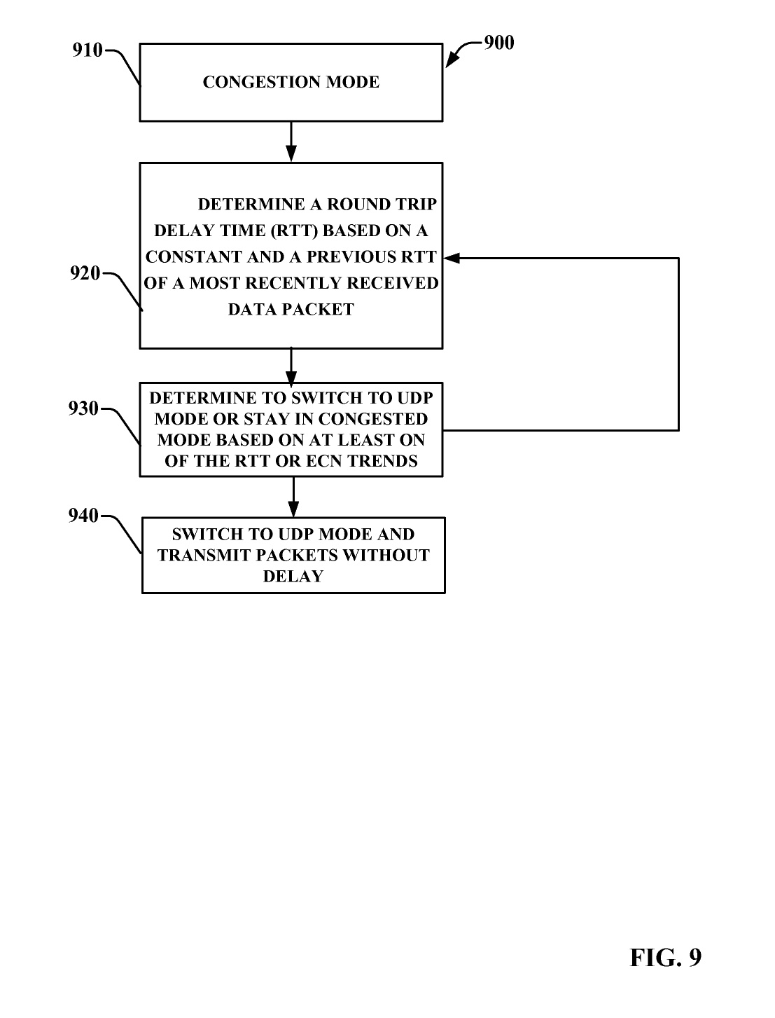

FIG. 9 presents a high level flow diagram of a method 900 for monitoring congestions of a network while in a congestions mode in accordance with the subject network management schemes of this disclosure. It is noted that various systems (e.g., system 600, system 500, system 400, etc.) can provide means for utilizing aspects of the method 900. At 910, a system is assumed to be in a congestion mode. In an aspect, 910 can include receivers acting in a congestion mode, senders acting in a congestion mode, an internet protocol interface acting in a congestion mode, and the like.

At 920, a RTT based on constants, and a previous RTT of a most recently received data packet is determined. In another aspect, RTT trends and/or ECN trends can be determined at 920.

At 930, it can be determined to switch to a UDP mode or stay in a congestion mode based on at least one of the RTT (RTT trends) or ECN trends (e.g., records of ECN markings). In an aspect, an ACK packet can be sent, for example, from a sender to a receiver. An ACK packet can include control information for system components, such as an OBS bit set to “1.” In another aspect, responsive packets (e.g., ACK2), CE code points, queue depths, and the like can be transmitted. If it is determined that the transmission mode should not be switch, the method 900 can continue at 920. If it is determined that the transmission mode should be witch, the method 900 can continue at 930. In an aspect, method 900 can iterated until it is determined to switch to UDP mode and the mode is switched.

At 930, the transmission mode can switch to a UDP mode and packets can be sent and/or received without delay. In an aspect, sending without delay can comprise sending data packets in a UDP-like manner (e.g., without a restricted sending rate).

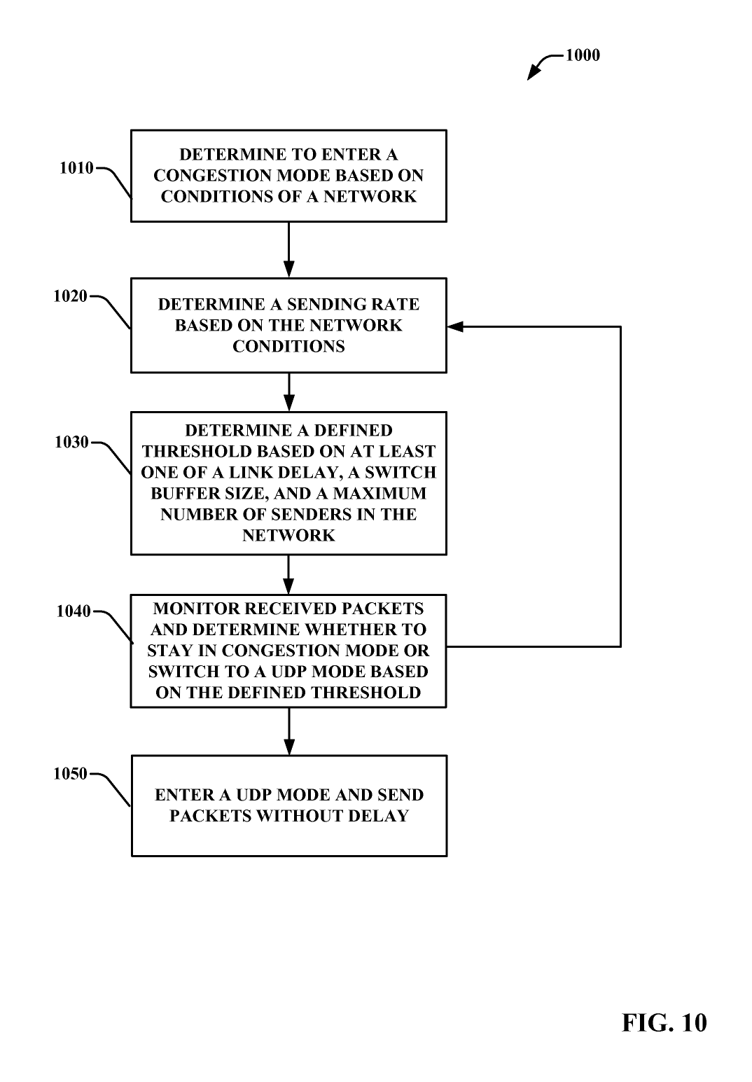

FIG. 10 presents a high level flow diagram of a method 1000 for managing congestion in a system in accordance with various aspects of this disclosure. At 1010, it is assumed that components of a system are connected through a network. Further, a server and a receiver are communicating (e.g., FIG. 6). At 1010, it can be determined to enter a congestion mode based on network conditions. At 1020, a sending rate based on the network conditions can be determined. In one aspect, determining the sending rate can include determining a rate to use to send data packets. In an aspect, the rate can be a modification of a current sending rate and can be a slower rate.

At 1030, a defined threshold can be determined based on at least one of a link delay, a switch buffer size, and a maximum number of senders in the network. In various implementations, the threshold is determined in accordance with aspects described herein.

At 1040, received packets are monitored and it is determined whether to stay in congestion mode or switch to a UDP mode. In an aspect, monitoring received packets can include receiving packets (e.g., control packets) from a receiver and processing control information in packets. In one aspect, if it is determined that a system should remain in congestion mode, the method 1000 can continue at 1020. If it is determine that the system should switch to UDP mode, the method 1000 can continue at 1050.

At 1050, a UDP mode can be entered and packets can be sent without delay. In an aspect, the congestion mode is exited as the UDP mode is entered. Exiting the congestion mode can comprise setting OBS bits to off for data packets, and the like.

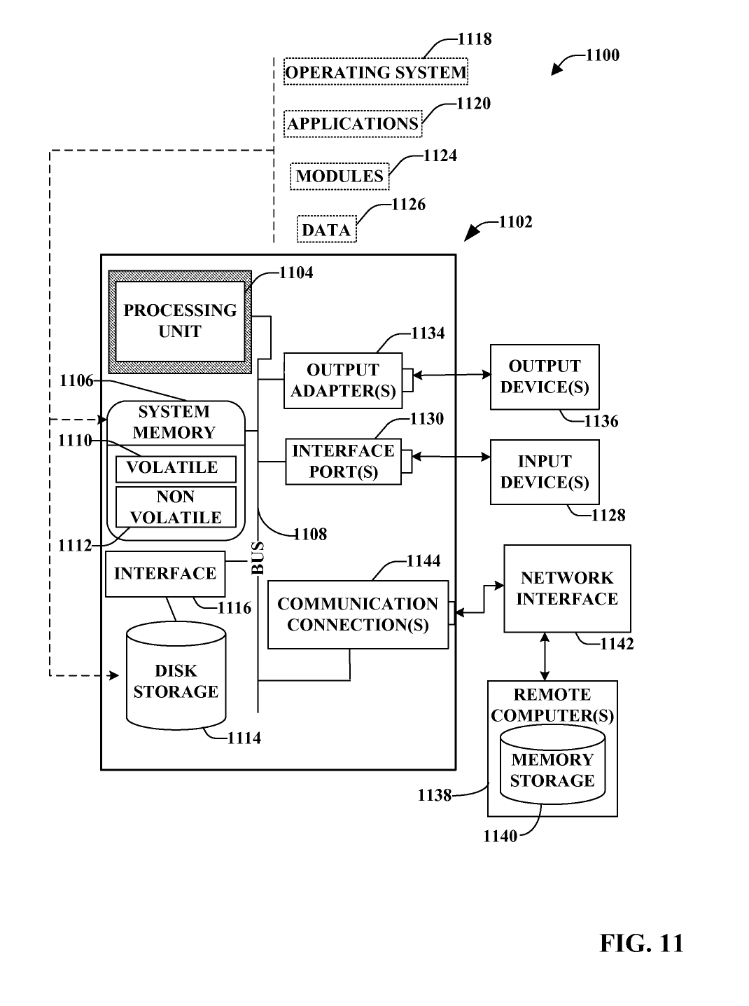

Referring now to FIG. 11, there is illustrated a block diagram of a computer operable to provide networking and communication capabilities between a wired or wireless communication network and a server and/or communication device. In order to provide additional context for various aspects thereof, FIG. 11 and the following discussion are intended to provide a brief, general description of a suitable computing environment 1100 in which the various aspects of the various embodiments can be implemented. While the description above is in the general context of computer-executable instructions that can run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments can also be practiced in distributed computing environments where certain tasks are performed by remote processing devices that are linked through a communications network. In a distributed computing environment, program modules can be located in both local and remote memory storage devices.

With reference to FIG. 11, a suitable environment 1100 for implementing various aspects of the claimed subject matter includes a computer 1102. The computer 1102 includes a processing unit 1104, a system memory 1106, a codec 1105, and a system bus 1108. The system bus 1108 couples system components including, but not limited to, the system memory 1106 to the processing unit 1104. The processing unit 1104 can be any of various available processors. Dual microprocessors and other multiprocessor architectures also can be employed as the processing unit 1104.

The system bus 1108 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1106 can include volatile memory 1110 and non-volatile memory 1112. The basic input/output system (BIOS), containing the basic routines to transfer information between elements within the computer 1102, such as during start-up, is stored in non-volatile memory 1112. By way of illustration, and not limitation, non-volatile memory 1112 can include read only memory (ROM), programmable ROM (PROM), electrically programmable ROM (EPROM), electrically erasable programmable ROM (EEPROM), or flash memory. Volatile memory 1110 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDRx SDRAM), and enhanced SDRAM (ESDRAM). Volatile memory 1110 can implement various aspects of this disclosure, including memory systems containing MASCH components.

Computer 1102 may also include removable/non-removable, volatile/non-volatile computer storage media. FIG. 11 illustrates, for example, a disk storage 1114. Disk storage 1114 includes, but is not limited to, devices like a magnetic disk drive, solid state disk (SSD) floppy disk drive, tape drive, Zip drive, LS-100 drive, flash memory card, or memory stick. In addition, disk storage 1114 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1114 to the system bus 1108, a removable or non-removable interface is typically used, such as interface 1116.

It is to be appreciated that FIG. 11 describes software, software in execution, hardware, and/or software in combination with hardware that acts as an intermediary between users and the basic computer resources described in the suitable operating environment 1100. Such software includes an operating system 1118. Operating system 1118, which can be stored on disk storage 1114, acts to control and allocate resources of the computer system 1102. Applications 1120 take advantage of the management of resources by operating system 1118 through program modules 1124, and program data 1126, such as the boot/shutdown transaction table and the like, stored either in system memory 1106 or on disk storage 1114. It is to be appreciated that the claimed subject matter can be implemented with various operating systems or combinations of operating systems. For example, applications 1120 and program data 1126 can include software implementing aspects of this disclosure.

A user enters commands or information into the computer 1102 through input device(s) 1128. Input devices 1128 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1104 through the system bus 1108 via interface port(s) 1130. Interface port(s) 1130 include, for example, a serial port, a parallel port, a game port, and a universal serial bus (USB). Output device(s) 1136 use some of the same type of ports as input device(s) 1128. Thus, for example, a USB port may be used to provide input to computer 1102 and to output information from computer 1102 to an output device 1136. Output adapter 1134 is provided to illustrate that there are some output devices 1136 like monitors, speakers, and printers, among other output devices 1136, which require special adapters. The output adapters 1134 include, by way of illustration and not limitation, video and sound cards that provide a means of connection between the output device 1136 and the system bus 1108. It should be noted that other devices and/or systems of devices provide both input and output capabilities such as remote computer(s) 1138.

Computer 1102 can operate in a networked environment using logical connections to one or more remote computers, such as remote computer(s) 1138. The remote computer(s) 1138 can be a personal computer, a server, a router, a network PC, a workstation, a microprocessor based appliance, a peer device, a smart phone, a tablet, or other network node, and typically includes many of the elements described relative to computer 1102. For purposes of brevity, only a memory storage device 1140 is illustrated with remote computer(s) 1138. Remote computer(s) 1138 is logically connected to computer 1102 through a network interface 1142 and then connected via communication connection(s) 1144. Network interface 1142 encompasses wire and/or wireless communication networks such as local-area networks (LAN), wide-area networks (WAN), and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1144 refers to the hardware/software employed to connect the network interface 1142 to the bus 1108. While communication connection 1144 is shown for illustrative clarity inside computer 1102, it can also be external to computer 1102. The hardware/software necessary for connection to the network interface 1142 includes, for exemplary purposes only, internal and external technologies such as, modems including regular telephone grade modems, cable modems and DSL modems, ISDN adapters, wired and wireless Ethernet cards, hubs, and routers. It is to be understood that aspects described herein may be implemented by hardware, software, firmware, or any combination thereof. When implemented in software, functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor may be a microprocessor, but, in the alternative, processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may comprise one or more modules operable to perform one or more of the s and/or actions described herein.

For a software implementation, techniques described herein may be implemented with modules (e.g., procedures, functions, and so on) that perform functions described herein. Software codes may be stored in memory units and executed by processors. Memory unit may be implemented within processor or external to processor, in which case memory unit can be communicatively coupled to processor through various means as is known in the art. Further, at least one processor may include one or more modules operable to perform functions described herein.

Techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2300, etc. UTRA includes Wideband-CDMA (W-CDMA) and other variants of CDMA. Further, CDMA2300 covers IS-2300, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.23, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA2300 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction, and/or data. Additionally, a computer program product may include a computer readable medium having one or more instructions or codes operable to cause a computer to perform functions described herein.

Further, the actions of a method or algorithm described in connection with aspects disclosed herein may be embodied directly in hardware, in a software module executed by a processor, or a combination thereof. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to processor, such that processor can read information from, and write information to, storage medium. In the alternative, storage medium may be integral to processor. Further, in some aspects, processor and storage medium may reside in an ASIC. Additionally, ASIC may reside in a user terminal. In the alternative, processor and storage medium may reside as discrete components in a user terminal. Additionally, in some aspects, the steps and/or actions of a method or algorithm may reside as one or any combination or set of codes and/or instructions on a machine-readable medium and/or computer readable medium, which may be incorporated into a computer program product.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

What is claimed is:

1. A system, comprising:
a processor that executes or facilitates execution of computer executable components stored in a computer readable storage medium, the computer executable components, comprising:
a network monitor component configured to determine a network congestion level of a network based on a function of transmissions waiting processing; and
a congestion control component configured to:
determine a transmission mode based on the network congestion level and a function of a network congestion threshold; and
determine a sending rate, for transmissions, based on the transmission mode.

2. The system of claim 1, wherein the network monitor component is configured to determine the network congestion level based on a flag that is modified based on whether a queue depth is determined to satisfy another function of a defined threshold.

3. The system of claim 1, wherein the network monitor component is further configured to monitor a set of transmissions including data indicating at least one of respective times of the set of transmissions, respective flags based on the network congestion level, and respective types of the set of transmissions.

4. The system of claim 3, wherein the network monitor component is further configured to determine a trend of the network based on an output of the set of transmissions being monitored.

5. The system of claim 4, wherein, to determine the trend, the network monitor component is further configured to store K round trip delay time (RTT) values and determine a number of the K RTT values that are smaller than a previously received RTT value, wherein K is an integer.

6. The system of claim 2, wherein the network monitor component is further configured to determine the defined threshold based on at least one of a link delay, a switch buffer size, and a maximum number of senders in the network.

7. The system of claim 1, wherein the transmissions are constrained by another function of a minimum rate and a maximum rate represented by the sending rate.

8. The system of claim 1, further comprising a communication component configured to establish a handshake connection and drop transmissions based on the congestion level and the transmission mode.

9. A method, comprising:
determining, by a system comprising a processor, a congestion level of transmissions of a network based on a data packet queue depth;
determining a transmission mode based on the congestion level of the network; and
determining a sending rate for a sender to receiver data packets based on the congestion level.

10. The method of claim 9 further comprising switching the transmission mode in response to the congestion level being determined to satisfy a function of a threshold.

11. The method of claim 9 further comprising altering a flag representing a transmission mode, the flag being represented in packetized data based on the transmission mode.

12. The method of claim 10, wherein determining the transmission mode comprises:
determining the transmission mode is a non-congested mode when the congestion level is below a threshold; and
determining the transmission mode is a congested mode when the congestion level meets or accedes the threshold.

13. The method of claim 10, further comprising:
sending data packets without delay in response to determining the transmission mode is the non-congested mode; and
sending data packets at a determined rate in response to determining the transmission mode is the congested mode.

14. The method of claim 10, wherein the switching the transmission mode is based in part on determining a trend of the network.

15. The method of claim 14, wherein, in response to determining the transmission mode is the congested mode, the determining the trend comprises determining at least one of round trip delay time values for each data packet of a set of data packets of the transmissions or determining explicit congestion notification marking trends of the set of data packets of the transmissions.

16. The method of claim 14, wherein, in response to determining the transmission mode is the congested mode, the determining the trend comprises monitoring a set of data packets of the transmissions and counting a number of data packets of the set of data packets with a congestion experience flag determined to have been set.

17. The method of claim 9, wherein the queue is managed by an internet protocol interface and a congestion experience flag is set at the internet protocol interface.

18. A system, comprising:
means for determining a congestion level as a function of a network parameter, wherein the network parameter represents a level of congestion of a network at a point in time;
means for determining a transmission mode as a function of the network parameter; and
means for adjusting a sending rate of data packets as a function of the transmission mode.

19. The system of claim 18, wherein the network parameter comprises a queue depth of a switch queue, and the queue stores transmissions received from a set of sender devices.

20. The system of claim 18, further comprising:
means for determining round trip delay time values for a set of data packets; and
means for monitoring the set of data packets and counting a number of data packets of the set of data packets with a flag indicating that congestion is being experienced.

21. The system of claim 18, wherein the means for adjusting the sending rate comprises means for determining an updated sending rate based on a round trip delay time.

22. A computer-readable storage device comprising computer-executable instructions that, in response to execution, cause a device comprising a processor to perform operations, comprising:
determining a congestion level in a network at a time;
determining a transmission mode based on the congestion level;
determining a sending rate based on a network characteristic and the transmission mode; and
configuring sending of the data packets to be based on the sending rate.

23. The computer-readable storage device of claim 22, wherein the determining the congestion level comprises setting a congestion experience flag based on a set of data packets being determined to exceed a threshold characteristic.

24. The computer-readable storage device of claim 22, wherein the operations further comprise determining a transmission trend of the network based on a defined number of data packets.

25. The computer-readable storage device of claim 22, wherein the operations further comprise:
determining a round trip delay time (RTT) based on a constant and a previous RTT of a most recently received data packet; and
altering a sending interval of the sending rate based on the RTT.

26. The computer-readable storage device of claim 22, wherein the operations further comprise gradually altering an actual sending rate to the determined sending rate.
